(19) United States
(12) Patent Application Publication
(10) Pub. No.: US 2005/0007754 A1
(43) Pub. Date: Jan. 13, 2005

(54) Lighted image display

(76) Inventor: Ricky Creel, Barnwell, SC (US)

Correspondence Address: B. Craig Killough;Barnwell Whaley Patterson & Helms, LLC, P.O. Drawer H, Charleston, SC, 29402-0197, US

(21) Appl. No.: 10/616,640

(22) Filed: Jul. 10, 2003

(51) Int. Cl. F21V 7/00

(52) U.S. Cl. 362/31; 40/716; 40/564

(57) ABSTRACT

A lighted image display comprises an image frame box having a front panel, wherein a large portion of the front panel is transparent and is not imaged. A rear panel of the frame box is spaced apart from the front panel. The rear panel has an image formed upon it, or attached to it. An electric light is disposed between the front panel and the rear panel, and light is emitted from the electrical light between the front panel and the rear panel. The light is reflected from the rear panel through the transparent portion of the front panel. The image, such as a photograph, is lighted by the electrical light, and viewed through the transparent portion of the front panel.

### FIELD OF THE INVENTION

This invention is related to picture frames generally, and it is more particularly directed to a lighted image display box.

### BACKGROUND OF THE INVENTION

Picture frames are commonly known and used. Picture frames as known and used include box type picture frames that provide back lighting for transparencies, or back lighting for glass etchings. Picture frames having lights extending from a frontal portion, and directed at the picture, have also been used.

### SUMMARY OF THE PRESENT INVENTION

The present invention is a lighted image display that comprises an image frame box. The frame box has a front panel, wherein a portion of the front panel is transparent and is not imaged. A rear panel of the frame box is spaced apart from the front panel. The rear panel has an image formed upon it, or attached to it. An electric light is disposed between the front panel and the rear panel, and light is emitted from the electrical light between the front panel and the rear panel. The light is reflected from the rear panel through the transparent portion of the front panel. The image, such as a photograph, is lighted by the electrical light, and viewed through the transparent portion of the front panel.

### DESCRIPTION OF THE DRAWINGS

FIG. 1 is a front elevation of the lighted image display.

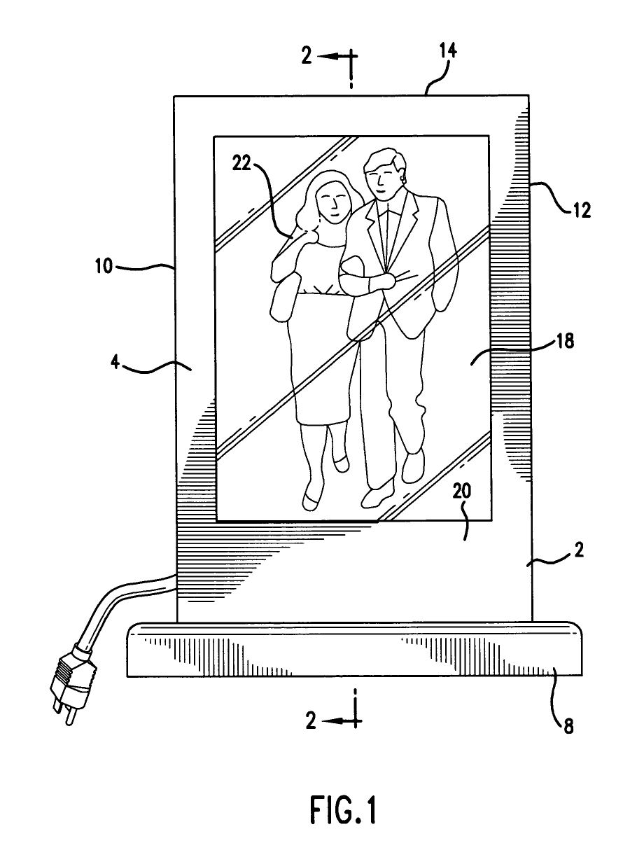

FIG. 2 is a side sectioned view taken essentially along line 2-2 of FIG. 1.

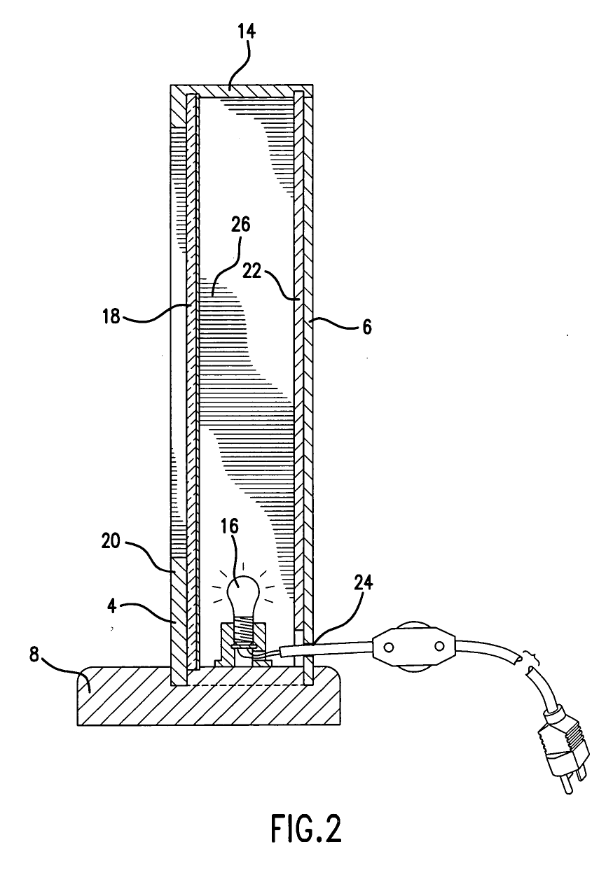

### DETAILED DESCRIPTION OF THE PREFERRED EMBODIMENT

Referring now to the drawing figures, the lighted image display of the present invention has an image frame box 2. The image frame box of the preferred embodiment has a front panel 4, a rear panel 6, a base 8, and three sides 10, 12, 14 that connect the front panel and the rear panel. The base is sufficiently wide to support the image frame box as it rests on a tabletop, a shelf or other flat surface. Positioned within the image frame box is an electrical light source 16.

The front panel is substantially planar. The front panel comprises a transparent portion 18 and an opaque portion 20. The transparent portion must comprise at least 50% of the surface area of the front panel. The transparent portion allows an image 22 that is present upon, or positioned against, the rear panel, to be viewed without obstruction. Accordingly, the transparent portion of the front panel is not imaged in a manner that will interfere with viewing the image that is on the rear panel. The transparent portion of the panel may been tinted, or it may have a glare resistant coating, but it is critical to the invention that the transparent portion not have imaging that interferes with, or obstructs, the view of the image that is present on the back panel of the display. A lower portion of the front panel is opaque, and is used to obstruct the view of the light source, so that the light bulb or other light source is not directly seen from the front of the device when the light box is at eye level. In a preferred embodiment, the transparent portion of the device may be constructed of glass or transparent plastic, and the opaque portion may be constructed of wood, plastic or other opaque material. Similarly, the rear panel, the base and the side panels may be constructed of the same material as the opaque portion of the front panel.

The rear panel is a planar panel, with the plane of the rear panel being substantially parallel to the plane of the front panel. The rear panel is spaced apart from the front panel. The spacing of the rear panel from the front panel will depend upon the size of the device and the image that is to be displayed on the rear panel, however, preferred lighting of the image indicates that the panel should not be less than 2.5 centimeters from the front panel.

The rear panel comprises an image 22. The image may be formed directly on the rear panel, or it may be an image that is attached to the rear panel. For example, the image to be displayed could be art work, such as stained glass, printed wood or paper, or the like. However, in the preferred embodiment, the rear panel has a photograph attached to the rear panel, with a provision made for the rear panel to be easily accessible, so that the photograph may be attached to, and detached from, the rear panel. Accordingly, the rear panel could be hinged or otherwise attached to the box, so that the inside of the rear panel is accessible. The photograph may be changed from time to time, as is common with pictures that are contained in picture frames.

In a lower portion of the rear panel, a conduit 24 is provided for electrical lighting. As shown in the preferred embodiment, a void is present that receives and holds an incandescent light bulb. The incandescent light bulb is powered by 115 volt alternating current. However, the electrical lighting could be provided by direct current from batteries, or by light emitting diodes, or by other known electrical lighting sources. The electrical light source in positioned between the front panel and the rear panel, so that light is emitted between the front panel and the rear panel. Light strikes the image on the rear panel, and it is reflected through the transparent portion of the front panel, to enhance the image. The image may be viewed when room lights are turned off. The device can serve as a nightlight to be used in bedrooms, hallways and the like, and to provide a relatively low level of lighting intensity.

In the preferred embodiment, and as shown, the front panel and the rear panel are joined by four sides, which includes the base. As shown in the drawing figures, the base extends beyond the front panel to provide additional support. In one embodiment of the invention, at least a portion of the interior of the four sides is reflective 26, so as to direct light toward the image and increase the light that is reflected by the image.

1. A lighted image display, comprising
an image frame box, said image frame box comprising,
a front panel, said front panel comprising a transparent portion that is not imaged, and a lower opaque portion,
a rear panel that is spaced apart from said front panel, said rear panel comprising an image that is viewable through said transparent portion of said front panel,
an electrical light that is disposed between said front panel and said rear panel, wherein said electrical light is positioned between said lower opaque portion of said front panel and said rear panel, said below said transparent portion of said front panel, and
wherein said electrical light emits light that is reflected by said image and through said transparent portion of said front panel.

2. A lighted image display as described in claim 1, wherein said image is a photograph, and wherein said photograph is positioned against said rear panel and between said rear panel and said front panel.

3. A lighted image display as described in claim 1, wherein said transparent portion of said front panel comprises not less than 50% of the front surface area of said front panel.

4. A lighted image display as described in claim 1, wherein said front panel and said rear panel are substantially parallel to each other.

5. A lighted image display as described in claim 1, wherein said front panel and said rear panel are joined by four sides, and wherein at least a portion of an interior of said four sides comprises a reflective material.

6. A lighted image display as described in claim 1, wherein said front panel is spaced apart from said rear panel by not less than 2.5 centimeters.
